(19) United States
(12) Patent Application Publication
(10) Pub. No.: US 2004/0145245 A1
(43) Pub. Date: Jul. 29, 2004

(54) Light control circuit of led lamp

(76) Inventor: Jen Yen Yen, Chang Hua (TW)

Correspondence Address: Jen Yen Yen, 235 Chung-Ho, BOX 8-24, Taipei, TW

(21) Appl. No.: 10/351,091

(22) Filed: Jan. 27, 2003

(51) Int. Cl. H02B 1/24

(52) U.S. Cl. 307/116

(57) ABSTRACT

A light control circuit of an LED lamp body comprises a power circuit, a pulse signal generator, a sound wave sensor circuit, a trigger driving circuit, and an LED light emitting circuit. When a user touches the lamp body, the pulse signal generator will generate a signal to the trigger driving circuit to bias and thus the driving transistor is conducted to light up the LEDs. Similarly, when a user emits a sound, the sound will be pickup by the sound pickup circuit by the sound wave sensor circuit as a sound signal. Then the sound signal is amplified so as to conduct the trigger driving circuit and the pulse signal generator. When the user is near the lamp body, the LEDs will light up continuously. If nobody is near the lamp body through a delay time the driving transistor will interrupt and thus LEDs distinguish.

### FIELD OF THE INVENTION

The present invention relates to LED lights, and particularly to a light control circuit of an LED lamp which can be controlled by touch-feeling or sound.

### BACKGROUND OF THE INVENTION

The prior art lamps are mainly made of silks instead of LEDs. LEDs are mainly used in indications. Moreover, in the prior art, the ways for switching the lights of a lamp is by pressing a switch. In some improved designs, touch feeling is used to control a lamp, but no lamp is controlled by sound or by both sound and touch feeling.

### SUMMARY OF THE INVENTION

Accordingly, the primary object of the present invention is to provide a light control circuit of an LED lamp. The LED lamp includes a seat, a lampshade, a control circuit board. The control circuit board is assembled to the seat. The lampshade is placed upon the seat; the control circuit board installed with a control circuit. The control circuit comprises a power circuit, a pulse signal generator, a sound wave sensor circuit, a trigger driving circuit, and an LED light emitting circuit. When a user touches the lamp body, the pulse signal generator will generate a signal to the trigger driving circuit to bias and thus conduct the driving transistor IC2 so as to light up the LEDs. Similarly, when a user emits a sound, the sound will be picked-up by the sound pickup circuit by the sound wave sensor circuit as a sound signal. Then the sound signal is amplified so as to conduct the trigger driving circuit and the pulse signal generator. When the user is near the lamp body, the LEDs will light up continuously. If nobody is near the lamp body through a delay time the driving transistor will interrupt and thus LEDs distinguish.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 shows the control circuit of the present invention.

FIG. 3 shows the flow diagram of the present invention.

### DETAILED DESCRIPTION OF THE PREFERRED EMBODIMENTS

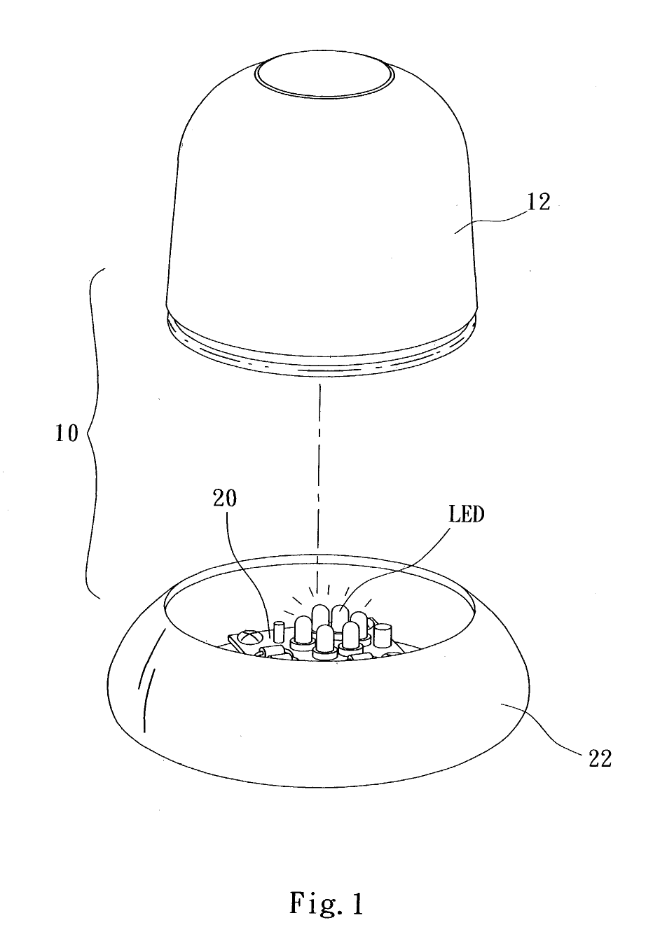

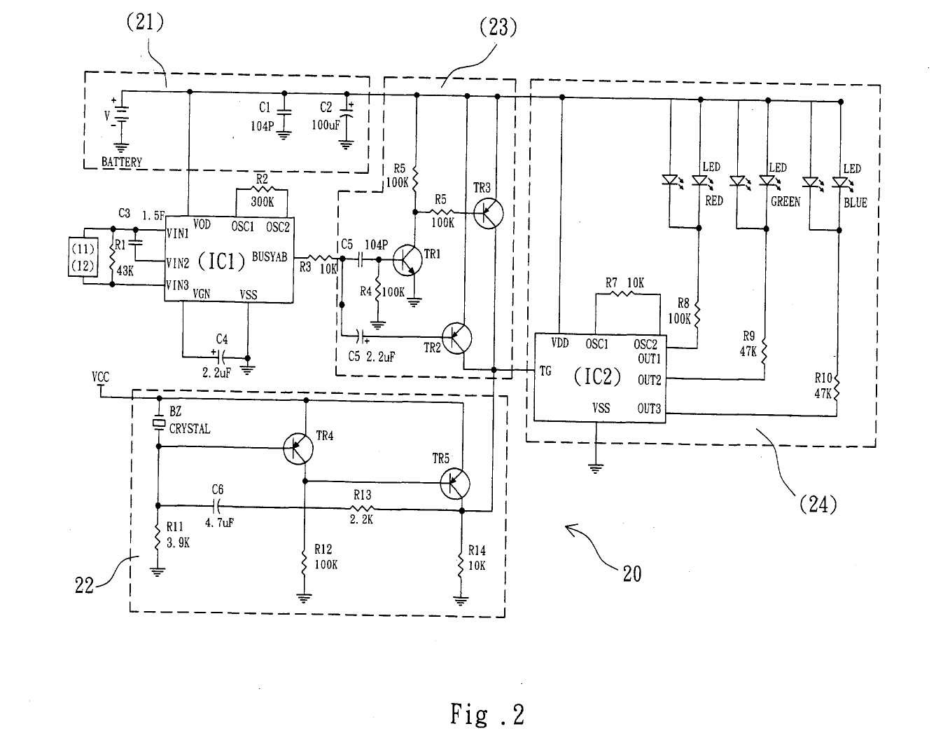

Referring to FIGS. 1 and 2, the light control circuit of an LED lamp body of the present invention is illustrated. The LED lamp body 10 includes a seat 11, a lampshade 12, a control circuit board 20. The control circuit board 20 is assembled to the seat 11. The lampshade 12 is placed upon the seat 11. The control circuit board 20 is installed with a control circuit. The control circuit comprises a power circuit 21, a pulse signal generator IC1, a sound wave sensor circuit 22, a trigger driving circuit 23, and an LED light emitting circuit 24.

The power circuit 21 supplies power to the trigger driving circuit 23 and the pulse signal generator IC1.

The pulse signal generator IC1 is electrically connected to the lampshade 12 and the seat 11 by wires; wherein when the lamp body is touched by the human body, a pulse is generated; and the pulse is then transferred to the trigger driving circuit 23.

The sound wave sensor circuit 22 has a sound pickup circuit BZ; transistors R4 and R5; wherein the sound pickup circuit BZ serves for receiving sound from for example a user, then the sound pickup circuit BZ generates a pulse to the transistors TR4 and TR4 sequentially for being amplified; then the amplified signal is transferred to the trigger driving circuit 23; The trigger driving circuit has transistors TR1, TR2, and TR3 for receiving signals from the pulse signal generator IC1 and the sound wave sensor circuit 22. The transistors TR1, TR2, and TR3 receives power from the power circuit 21. Signals from the pulse signal generator IC1 are transferred to the transistors TR1 and TR2 and output of TR1 is connected to the transistor TR2.

The LED light emitting circuit 24 has a driving transistor IC2 which is connected to the trigger driving circuit 23 and has a plurality of LEDs connected to the driving transistor IC2 for emitting lights of different colors; signals from one of the sound wave sensor circuit 22 and pulse signal generator IC1 will conduct the LEDs.

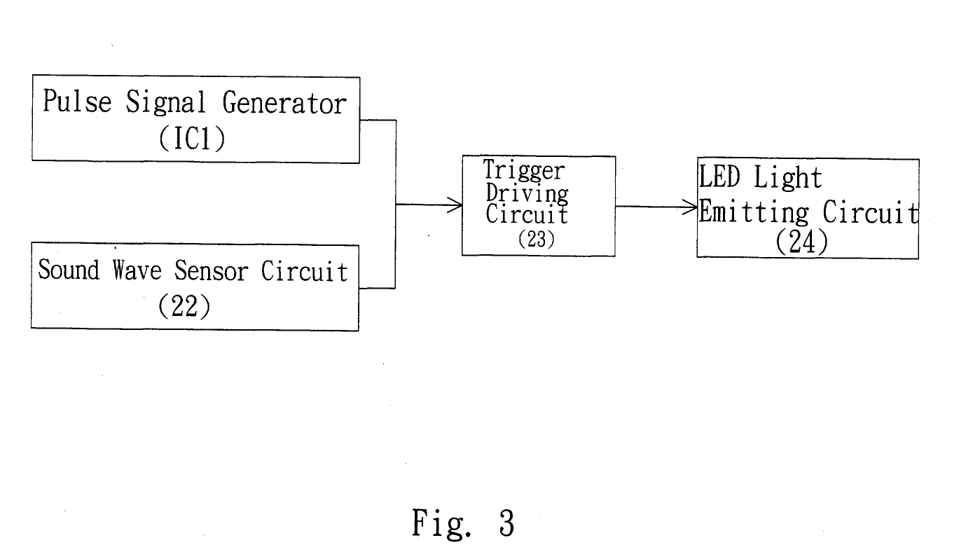

Referring to FIGS. 2 and 3, when a user touches the lamp body 10, the pulse signal generator IC1 will generate a signal to the trigger driving circuit 23 to bias and thus conduct the transistors TR1, TR2, and TR3. Thereby, the driving transistor IC2 is conducted to light up the LEDs.

Similarly, when a user emits a sound, the sound will be pickup by the sound pickup circuit BZ by the sound wave sensor circuit 22 as a sound signal. Then the sound signal is amplified by the transistors TR4 and TR5 so as to conduct the trigger driving circuit 23 and the pulse signal generator IC1. When the user is near the lamp body 10, the LEDs will light up continuously. If nobody is near the lamp body 10 through a delay time, the driving transistor IC2 will interrupt and thus LEDs distinguish.

Advantages of the present invention will be described herein.

The plurality of LEDs have various colors which can be controlled to present different colors.

LED lamps are used as light source instead of tungsten light. Thus DC current can be used for saving power.

The lamp body 10 is controlled by touch feeling and sound so that the user may well control the lamp body 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A light control circuit of an LED lamp body; the LED lamp body including a seat, a lampshade, a control circuit board; the control circuit board being assembled to the seat; the lampshade being placed upon the seat for covering the control circuit board; the control circuit board being installed with a control circuit; the control circuit comprising a power circuit, a pulse signal generator, a sound wave sensor circuit, a trigger driving circuit, and an LED light emitting circuit; wherein
the power circuit supplies power serves for supplying power to all elements in the light control circuit;
the pulse signal generator is electrically connected to the lampshade and the seat by wires; wherein when the lamp body is touched by human body, a pulse is generated; and the pulse is then transferred to the trigger driving circuit;
the sound wave sensor circuit has a sound pickup circuit and two first transistors connected in series; wherein the sound pickup circuit serves for receiving sounds, then generates a pulse to the first transistors sequentially for being amplified; then the amplified signal is transferred to the trigger driving circuit;
the trigger driving circuit has three second transistors for receiving signals from the pulse signal generator and the sound wave sensor circuit; the three second transistors receives power from the power circuit; signals from the pulse signal generator are transferred to the two first transistors which are connected in series; and
the LED light emitting circuit has a driving transistor which is connected to the trigger driving circuit and has a plurality of LEDs connected to the driving transistor for emitting lights of different colors; signals from one of the sound wave sensor circuit and pulse signal generator IC1 will conduct the LEDs.
